(19) United States
(12) Patent Application Publication
(10) Pub. No.: US 2014/0347614 A1
(43) Pub. Date: Nov. 27, 2014

(54) LIQUID CRYSTAL DISPLAY DEVICE

(71) Applicant: Sharp Kabushiki Kaisha, Osaka-shi, Osaka (JP)

(72) Inventors: Katsushige Asada, Osaka-shi (JP); Manabu Sawasaki, Osaka-shi (JP); Junichi Morinaga, Osaka-shi (JP); Masayuki Yamanaka, Osaka-shi (JP)

(21) Appl. No.: 14/371,472

(22) PCT Filed: Jan. 11, 2013
(86) PCT No.: PCT/JP2013/050366

§ 371 Date: Jul. 10, 2014

(30) Foreign Application Priority Data
Jan. 13, 2012 (JP) 2012-005670

(51) Int. Cl. G02F 1/1337; G02F 1/1339

(52) U.S. Cl. CPC G02F 1/1337; G02F 1/1339
USPC 349/123

(57) ABSTRACT

This liquid crystal display device (100) includes: a first substrate (10) including a pixel electrode (11); a second substrate (20) including a counter electrode (21); and a vertical alignment liquid crystal layer (30). At least one liquid crystal domain with axisymmetric alignment is produced when a voltage is applied between the pixel electrode and the counter electrode in each pixel. The second substrate further includes an alignment controlling projection which induces liquid crystal molecules (31) in the liquid crystal domain to get aligned axisymmetrically and a plurality of columnar spacers (24), which includes a first columnar spacer (24m) and a second columnar spacer (24s) which is lower than the first columnar spacer. The pixel electrode has a length of 35 μm or less as measured along its shorter sides. In at least some of the pixels, the second columnar spacer functions as the alignment controlling projection. And the height (Hs) of the second columnar spacer is 75% to 92% of the height (Hm) of the first columnar spacer.

### TECHNICAL FIELD

The present invention relates to a liquid crystal display device and more particularly relates to a vertical alignment (VA) mode liquid crystal display device in which liquid crystal domains with axisymmetric alignment are produced upon the application of a voltage.

### BACKGROUND ART

Liquid crystal display devices have a significantly reduced depth and will dissipate much less power than other kinds of display devices. By taking advantage of these features, liquid crystal display devices have recently been used extensively in various kinds of information devices including laptop personal computers, cellphones, and electronic organizers and videotape recorders with a built camera and an LCD monitor.

A vertical alignment (VA) mode which uses a vertical alignment liquid crystal layer has attracted a lot of attention these days as a display mode that would achieve a high contrast ratio and a wide viewing angle. A vertical alignment liquid crystal layer is generally comprised of a liquid crystal material with negative dielectric anisotropy and a vertical alignment film.

Patent Document No. 1 proposes a vertical alignment mode which is called a “CPA (continuous pinwheel alignment) mode”. In the CPA mode, typically a pixel electrode is divided by a hole and/or a notch at a predetermined position into a plurality of subpixel electrodes. When a voltage is applied to the liquid crystal layer, an oblique electric field is generated in the vicinity of the outer periphery of each of those subpixel electrodes, thereby producing axisymmetrically aligned liquid crystal domains with radially tilted orientations. As a result, a display operation can be carried out at a wide viewing angle.

Meanwhile, Patent Document No. 2 discloses a technique for stabilizing the axisymmetric alignments of liquid crystal molecules in the CPA mode. According to the technique of Patent Document No. 2, the axisymmetric alignment induced by the electrode structure of an active-matrix substrate (i.e., a pixel electrode which has been divided into a plurality of subpixel electrodes) is stabilized by an alignment control structure provided for the counter substrate. The alignment control structure is arranged in a region corresponding to substantially the center of a liquid crystal domain. The alignment control structure may be either a raised portion (which will be referred to herein as an “alignment controlling projection”) or a hole which has been cut through the counter electrode.

On the other hand, a PSA (polymer sustained alignment) technology has been proposed in order to increase the stability of alignment and response speed in the vertical alignment mode (see Patent Documents Nos. 3 and 4, for example). According to the PSA technology, the pretilt direction of liquid crystal molecules is controlled by putting a photo-polymerizable material on an alignment film. The photo-polymerizable material (which is also called an “alignment sustaining layer”) is obtained by introducing a small amount of a photo-polymerizable compound (such as a photo-polymerizable monomer) into a liquid crystal material and irradiating the photo-polymerizable compound with an ultraviolet ray with a predetermined voltage applied to the liquid crystal layer after the liquid crystal panel has been assembled. The alignment state of the liquid crystal molecules when the alignment sustaining layer is formed is sustained (i.e., memorized) by the alignment sustaining layer even after the voltage is removed (i.e., no longer applied). As a result, the stability of alignments and response speed can be increased.

### CITATION LIST

### Patent Literature

Patent Document No. 1: Japanese Laid-Open Patent Publication No. 2003-43525
Patent Document No. 2: Japanese Laid-Open Patent Publication No. 2002-202511
Patent Document No. 3: Japanese Laid-Open Patent Publication No. 2002-357830
Patent Document No. 4: Japanese Laid-Open Patent Publication No. 2003-307720

### SUMMARY OF INVENTION

### Technical Problem

Recently, as smart phones and tablet display devices have become increasingly popular, it has become more and more common these days to design those electronic devices so that an input device such as a touchscreen panel is arranged on an LCD panel. Thus, those electronic devices are more and more often designed to be used by having the user apply stress intentionally onto the surface of the liquid crystal display device.

However, in a situation where a CPA mode liquid crystal display device is used in that way, even if an alignment control structure is provided for the counter substrate, it is still difficult to stabilize the axisymmetric alignment sufficiently. For that reason, if the user puts his or her finger or a dedicated input tool (i.e., a so-called “stylus”) on the surface of the liquid crystal display device, the trace could be left (or recognized) as a kind of display unevenness. Such unevenness (which will be referred to herein as “trace unevenness”) would cause a decline in display quality.

The axisymmetric alignment could be stabilized by not only providing such an alignment control structure for the counter substrate but also adopting the PSA technology. In that case, however, when the LCD panel is fabricated, the process step of forming an alignment sustaining layer should be performed. That is why it would take a longer time and an increased cost to get the manufacturing process done. In addition, even if the PSA technology is adopted, the trace unevenness may not be reduced sufficiently.

The present inventors perfected our invention in order to overcome these problems by providing a CPA mode liquid crystal display device with significantly reduced trace unevenness.

### Solution to Problem

A liquid crystal display device according to an embodiment of the present invention includes: a plurality of pixels arranged in a matrix pattern; a first substrate on which a pixel electrode is provided for each of the plurality of pixels; a second substrate including a counter electrode arranged to face the pixel electrodes; and a vertical alignment liquid crystal layer interposed between the first and second substrates. At least one liquid crystal domain with axisymmetric alignment is produced when a voltage is applied between the pixel electrode and the counter electrode in each of the plurality of pixels. The second substrate further includes an alignment controlling projection and a plurality of columnar spacers. The projection is arranged in a region corresponding to substantially the center of the at least one liquid crystal domain and induces liquid crystal molecules in the at least one liquid crystal domain to get aligned axisymmetrically. The plurality of columnar spacers includes a first columnar spacer and a second columnar spacer which is lower than the first columnar spacer. The pixel electrode has a length of 35 μm or less as measured along its shorter sides. In at least some of the pixels, the second columnar spacer functions as the alignment controlling projection. And the height of the second columnar spacer is 75% to 92% of that of the first columnar spacer.

In one embodiment, the at least one liquid crystal domain includes a plurality of liquid crystal domains, and the pixel electrode includes a plurality of subpixel electrodes associated with the plurality of liquid crystal domains.

In one embodiment, the first substrate further includes a thin-film transistor provided for each of the plurality of pixels and an interlayer insulating film covering the thin-film transistors. A contact hole is cut through the interlayer insulating film to electrically connect the pixel electrode to the thin-film transistor. And the contact hole is arranged so as to overlap with the alignment controlling projection that is associated with one of the plurality of liquid crystal domains when viewed along a normal to a display screen.

In one embodiment, the thin-film transistor is arranged so as to overlap with the alignment controlling projection that is associated with another one of the plurality of liquid crystal domains when viewed along a normal to the display screen.

In one embodiment, the second substrate further includes a shielding layer, which includes first and second shielding portions which overlap with the contact hole and the thin-film transistor, respectively, when viewed along a normal to the display screen.

In one embodiment, in each of the plurality of pixels, the second columnar spacer functions as the alignment controlling projection that is associated with at least some of the plurality of liquid crystal domains.

In one embodiment, the plurality of pixels includes a pixel in which the first columnar spacer functions as the alignment controlling projection.

In one embodiment, the at least one liquid crystal domain includes only one liquid crystal domain.

In one embodiment, the first substrate further includes a thin-film transistor provided for each of the plurality of pixels, and the thin-film transistor is arranged so as to overlap with the alignment controlling projection when viewed along a normal to the display screen.

In one embodiment, the second substrate further includes a shielding layer, which includes a shielding portion that overlaps with the thin-film transistor when viewed along a normal to the display screen.

In one embodiment, in some of the plurality of pixels, the first columnar spacer functions as the alignment controlling projection and in the other pixels, the second columnar spacer functions as the alignment controlling projection.

In one embodiment, each of the plurality of columnar spacers is either the first or second columnar spacer that functions as the alignment controlling projection, and the second substrate has no additional columnar spacers which are provided anywhere but the region corresponding to substantially the center of the at least one liquid crystal domain.

In one embodiment, the second columnar spacer is lower by approximately 0.5 μm than the first columnar spacer.

Another liquid crystal display device according to an embodiment of the present invention includes: a plurality of pixels arranged in a matrix pattern; a first substrate on which a pixel electrode is provided for each of the plurality of pixels; a second substrate including a counter electrode arranged to face the pixel electrodes; and a vertical alignment liquid crystal layer interposed between the first and second substrates. At least one liquid crystal domain with axisymmetric alignment is produced when a voltage is applied between the pixel electrode and the counter electrode in each of the plurality of pixels. The first substrate further includes a thin-film transistor provided for each of the plurality of pixels. The second substrate further includes an alignment controlling projection and a plurality of columnar spacers. The projection is arranged in a region corresponding to substantially the center of the at least one liquid crystal domain and induces liquid crystal molecules in the at least one liquid crystal domain to get aligned axisymmetrically. The plurality of columnar spacers includes a first columnar spacer and a second columnar spacer which is lower than the first columnar spacer. In at least some of the pixels, the second columnar spacer functions as the alignment controlling projection. And the thin-film transistor is arranged so as to overlap with the alignment controlling projection that is associated with one of the at least one liquid crystal domain when viewed along a normal to a display screen.

In one embodiment, the at least one liquid crystal domain includes a plurality of liquid crystal domains, and the pixel electrode includes a plurality of subpixel electrodes associated with the plurality of liquid crystal domains.

In one embodiment, the first substrate further includes an interlayer insulating film covering the thin-film transistors. A contact hole is cut through the interlayer insulating film to electrically connect the pixel electrode to the thin-film transistor. And the contact hole is arranged so as to overlap with the alignment controlling projection that is associated with one of the plurality of liquid crystal domains when viewed along a normal to the display screen.

In one embodiment, the second substrate further includes a shielding layer, which includes first and second shielding portions that overlap with the contact hole and the thin-film transistor, respectively, when viewed along a normal to the display screen.

In one embodiment, in each of the plurality of pixels, the second columnar spacer functions as the alignment controlling projection that is associated with at least some of the plurality of liquid crystal domains.

In one embodiment, the plurality of pixels includes a pixel in which the first columnar spacer functions as the alignment controlling projection.

In one embodiment, the at least one liquid crystal domain includes only one liquid crystal domain.

In one embodiment, the second substrate further includes a shielding layer, which includes a shielding portion that overlaps with the thin-film transistor when viewed along a normal to the display screen.

In one embodiment, in some of the plurality of pixels, the first columnar spacer functions as the alignment controlling projection and in the other pixels, the second columnar spacer functions as the alignment controlling projection.

In one embodiment, each of the plurality of columnar spacers is either the first or second columnar spacer that functions as the alignment controlling projection, and the second substrate has no additional columnar spacers which are provided anywhere but the region corresponding to substantially the center of the at least one liquid crystal domain.

In one embodiment, the plurality of columnar spacers has a lower relative dielectric constant than the liquid crystal layer.

In one embodiment, the first substrate further includes a signal line which is electrically connected to the drain electrode of the thin-film transistor of a pixel belonging to a row of pixels, and the signal line meanders so as to run across respective pixels of its associated row of pixels.

### Advantageous Effects of Invention

An embodiment of the present invention provides a CPA mode liquid crystal display device which can minimize the trace unevenness.

### BRIEF DESCRIPTION OF DRAWINGS

FIG. 1 A plan view schematically illustrating a liquid crystal display device 100 as an embodiment of the present invention.

FIG. 2 (a) and (b) are cross-sectional views as respectively viewed on the planes 2A-2A′ and 2B-2B′ shown in FIG. 1.

FIG. 3 (a) is a plan view schematically illustrating a liquid crystal display device 100 as an embodiment of the present invention and (b) is a cross-sectional view as viewed on the plane 2B-2B′ shown in FIG. 1.

FIG. 4 A cross-sectional view as viewed on the plane 2B-2B′ shown in FIG. 1.

FIG. 5 A plan view schematically illustrating a liquid crystal display device 700 as a comparative example.

FIG. 6 (a) and (b) are cross-sectional views as respectively viewed on the planes 6A-6A′ and 6B-6B′ shown in FIG. 5.

FIG. 7 A plan view schematically illustrating a liquid crystal display device 800 as another comparative example.

FIG. 8 (a) and (b) are cross-sectional views as respectively viewed on the planes 8A-8A′ and 8B-8B′ shown in FIG. 7.

FIG. 9 (a), (b) and (c) illustrate how trace unevenness arises in principle in the liquid crystal display device 800 of the comparative example, for instance.

FIG. 10 (a) is a micrograph of the liquid crystal display device in the white display state in which trace unevenness has occurred and (b) illustrates, on a larger scale, a pixel in which the trace unevenness has occurred.

FIG. 11 Shows the result of a simulation that was carried out on the liquid crystal display device 100 of an embodiment of the present invention (i.e., having the specifications of Example #2) to predict the alignment of the liquid crystal molecules 31 when a voltage is applied to the liquid crystal layer 30.

FIG. 12 (a) and (b) show the results of simulations that were carried out on the liquid crystal display device 100 of this embodiment (i.e., having the specifications of Example #2) to predict the transmittances of a pixel when a voltage is applied to the liquid crystal layer 30.

FIG. 13 (a) and (b) show the results of simulations that were carried out on the liquid crystal display device 100 of this embodiment (i.e., having the specifications of Example #2) to predict the transmittances of a pixel when a voltage is applied to the liquid crystal layer 30.

FIG. 14 Shows the result of a simulation that was carried out on the liquid crystal display device 700 of a comparative example (i.e., having the specifications of Comparative Example #1) to predict the alignment of the liquid crystal molecules 31 when a voltage is applied to the liquid crystal layer 30.

FIG. 15 (a) and (b) show the results of simulations that were carried out on the liquid crystal display device 700 of the comparative example (i.e., having the specifications of Comparative Example #1) to predict the transmittances of a pixel when a voltage is applied to the liquid crystal layer 30.

FIG. 16 A plan view schematically illustrating a liquid crystal display device 100′ as another embodiment of the present invention.

FIG. 17 A cross-sectional view as viewed on the plane 17A-17A′ shown in FIG. 16.

FIG. 18 A cross-sectional view as viewed on the plane 17A-17A′ shown in FIG. 16.

FIG. 19 Shows the result of a simulation that was carried out on the liquid crystal display device 100′ of another embodiment of the present invention to predict the alignment of the liquid crystal molecules 31 when a voltage is applied to the liquid crystal layer 30.

FIG. 20 (a) and (b) show the results of simulations that were carried out on the liquid crystal display device 100′ as another embodiment to predict the transmittances of a pixel when a voltage is applied to the liquid crystal layer 30.

FIG. 21 (a) and (b) show the results of simulations that were carried out on the liquid crystal display device 100′ as another embodiment to predict the transmittances of a pixel when a voltage is applied to the liquid crystal layer 30.

### DESCRIPTION OF EMBODIMENTS

Hereinafter, embodiments of the present invention will be described with reference to the accompanying drawings. It should be noted that the present invention is in no way limited to the embodiments to be described below.

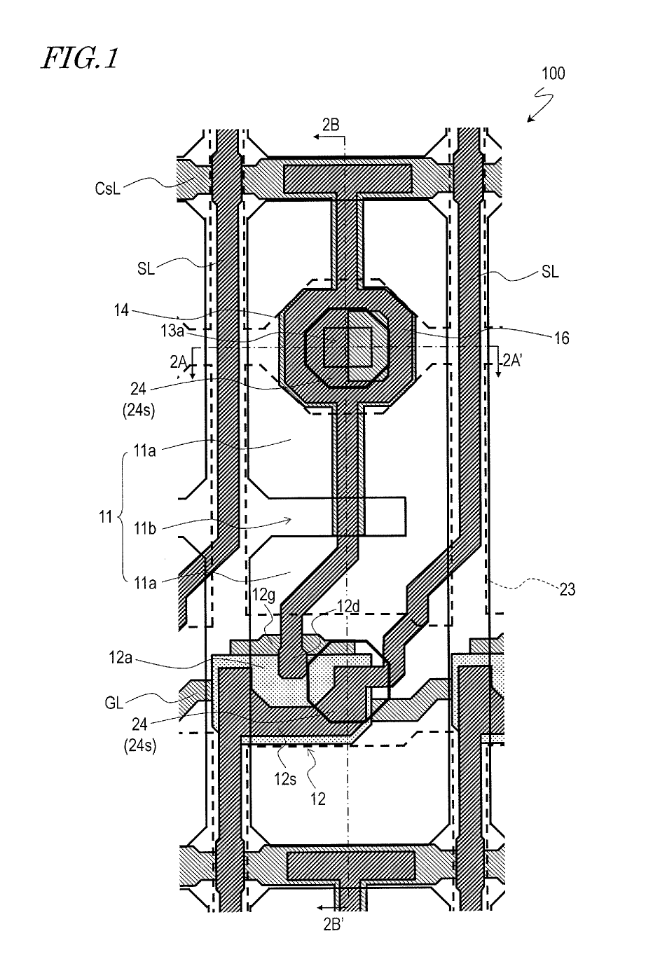

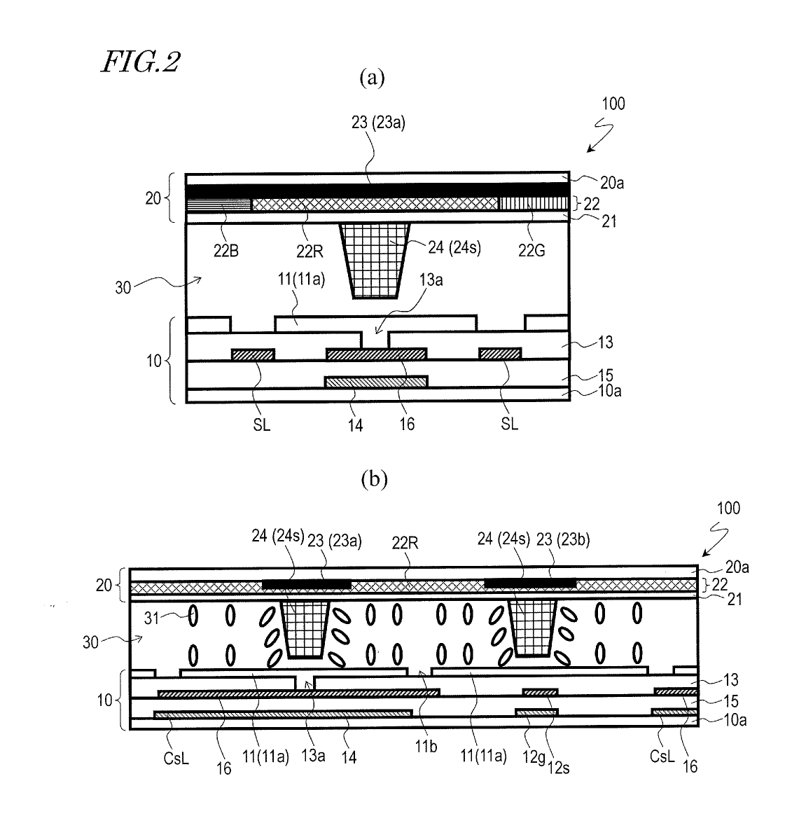

FIGS. 1, 2(a) and 2(b) illustrate a liquid crystal display device 100 as an embodiment. FIG. 1 is a plan view schematically illustrating the liquid crystal display device 100. FIGS. 2(a) and 2(b) are cross-sectional views as respectively viewed on the planes 2A-2A′ and 2B-2B′ shown in FIG. 1.

This liquid crystal display device 100 includes a plurality of pixels which are arranged in a matrix pattern. In FIG. 1, illustrated is a region corresponding to a single pixel. As shown in FIGS. 2(a) and 2(b), this liquid crystal display device 100 includes an active-matrix substrate (first substrate) 10, a counter substrate (second substrate) 20 which faces the active-matrix substrate 10, and a liquid crystal layer 30 interposed between the active-matrix substrate 10 and the counter substrate 20.

The active-matrix substrate (first substrate) 10 includes a pixel electrode 11 which is provided for each of the plurality of pixels. The pixel electrode 11 is typically made of a transparent conductive material (such as ITO). As shown in FIG. 1, the pixel electrode 11 includes a plurality of subpixel electrodes 11a. In this embodiment, the pixel electrode 11 is divided into two subpixel electrodes 11a by a notched portion (slit) 11b.

The active-matrix substrate 10 further includes a thin-film transistor (TFT) 12 which is provided for each of the plurality of pixels and an interlayer insulating film 13 which covers the TFT 12. The TFT 12 includes a gate electrode 12g, a source electrode 12s, a drain electrode 12d and a semiconductor layer 12a. A contact hole 13a to electrically connect the pixel electrode 11 to the TFT 12 has been cut through the interlayer insulating film 13.

These components of the active-matrix substrate 10, including the pixel electrode 11, TFT 12 and interlayer insulating film 13 described above, are arranged on a transparent substrate 10a with an electrically insulating property (which is typically a glass substrate).

Specifically, on the surface of the transparent substrate 10a that faces the liquid crystal layer 30, arranged are not only the gate electrode 12g of the TFT 12 but also a scan line GL, a storage capacitor line CsL and a storage capacitor counter electrode 14. The scan line GL is electrically connected to the gate electrode 12g of the TFT 12 and supplies a scan signal to the TFT 12. The storage capacitor line CsL is electrically connected to the storage capacitor counter electrode 14 and applies a storage capacitor counter voltage to the storage capacitor counter electrode 14.

A gate insulating film 15 has been formed so as to cover the gate electrode 12g and the scan line GL. On the gate insulating film 15, arranged are not only the source and drain electrodes 12s and 12d of the TFT 12 but also a signal line SL and a storage capacitor electrode 16. On a portion of the gate insulating film 15 which faces the gate electrode 12g, arranged is the semiconductor layer 12a of the TFT 12 (not shown in FIG. 2(b)). The signal line SL is electrically connected to the source electrode 12s of the TFY 12 and supplies a display signal to the TFT 12. The storage capacitor electrode 16 is electrically connected to the drain electrode 12d of the TFT 12.

The interlayer insulating film 13 has been formed so as to cover the source and drain electrodes 12s and 12d of the TFT 12 and the signal line SL. The pixel electrode 11 has been formed on the interlayer insulating film 13. The pixel electrode 11 is connected to the storage capacitor electrode 16 through the contact hole 13a and electrically connected to the drain electrode 12d of the TFT 12 via the storage capacitor electrode 16.

The counter substrate 20 includes a counter electrode 21 which is arranged to face the pixel electrode 11. The counter electrode 21 is made of a transparent conductive material (such as ITO). The pixel electrodes 11 are provided for respective pixels independently of each other. On the other hand, the counter electrode 21 is typically a single continuous conductive film which covers the entire display area and is an electrode to be shared in common by every pixel (i.e., a common electrode).

In addition, the counter substrate 20 further includes a color filter layer 22 and a shielding layer 23. The color filter layer 22 includes a red color filter 22R which is provided for a pixel to display the color red, a green color filter 22G which is provided for a pixel to display the color green, and a blue color filter 22B which is provided for a pixel to display the color blue. The shielding layer 23 (of which the outer periphery is indicated by the dotted line in FIG. 1) includes a contact hole shielding portion 23a and a TFT shielding portion 23b which overlap with the contact hole 13a and the TFT 12, respectively, when viewed along a normal to the display screen.

The counter substrate 20 further includes a plurality of columnar spacers 24, which may be made of a photosensitive resin, for example. Those columnar spacers 24 include a first type of columnar spacers (main spacers) (not shown in FIG. 1) and a second type of columnar spacers (sub-spacers) 24s which are lower than the first type of columnar spacers.

Generally speaking, in a liquid crystal display device of the type that uses columnar spacers, if the density of columnar spacers (i.e., the number of columnar spacers per unit area) were increased to enhance the withstand load thereof, it would be more and more difficult for the cell gap to catch up with the shrinkage of a liquid crystal layer that could occur at a low temperature. As a result, bubbles would be produced in the liquid crystal layer (which phenomenon will be referred to herein as “low-temperature bubbling”). However, if two different types of columnar spacers 24 with mutually different heights are provided and if the cell gap is controlled using basically only the main spacers (i.e., the higher columnar spacers) as is done in this embodiment, the effective spacer density will be defined by only the main spacers, and it will be easier for the cell gap to catch up with the shrinkage of the liquid crystal layer 30. Also, if the cell gap has become narrower due to a load imposed on the LCD panel, then the two substrates will be supported by both the main spacers and the sub-spacers (i.e., the lower columnar spacers) 24s. In that case, the effective spacer density will be defined by both the main spacers and the sub-spacers 24s, and therefore, a high withstand load can be achieved. As can be seen, by providing two types of columnar spacers 24 with mutually different heights, low-temperature bubbling can be suppressed and the withstand load can be increased at the same time.

The components of the counter substrate 20, including the counter electrode 21 and the color filter layer 22 described above, are arranged on a transparent substrate 20a with an electrically insulating property (which is typically a glass substrate). Specifically, the color filter layer 22 and the shielding layer 23 are arranged on the surface of the transparent substrate 20a that faces the liquid crystal layer 30, and the counter electrode 21 is arranged over those layers. And those columnar spacers 24 are dispersed over the counter electrode 21.

The liquid crystal layer 30 is a vertical alignment liquid crystal layer. That is to say, the liquid crystal molecules 31 included in the liquid crystal layer 30 have negative dielectric anisotropy and are aligned substantially perpendicularly to (typically so as to define a pretilt angle of 85 degrees or more with respect to) the surface of the substrate as shown in FIG. 2(b) when no voltage is applied between the pixel electrode 11 and the counter electrode 21. Although not shown, each of the active-matrix substrate 10 and counter substrate 20 has its surface that faces the liquid crystal layer 30 covered with a vertical alignment film.

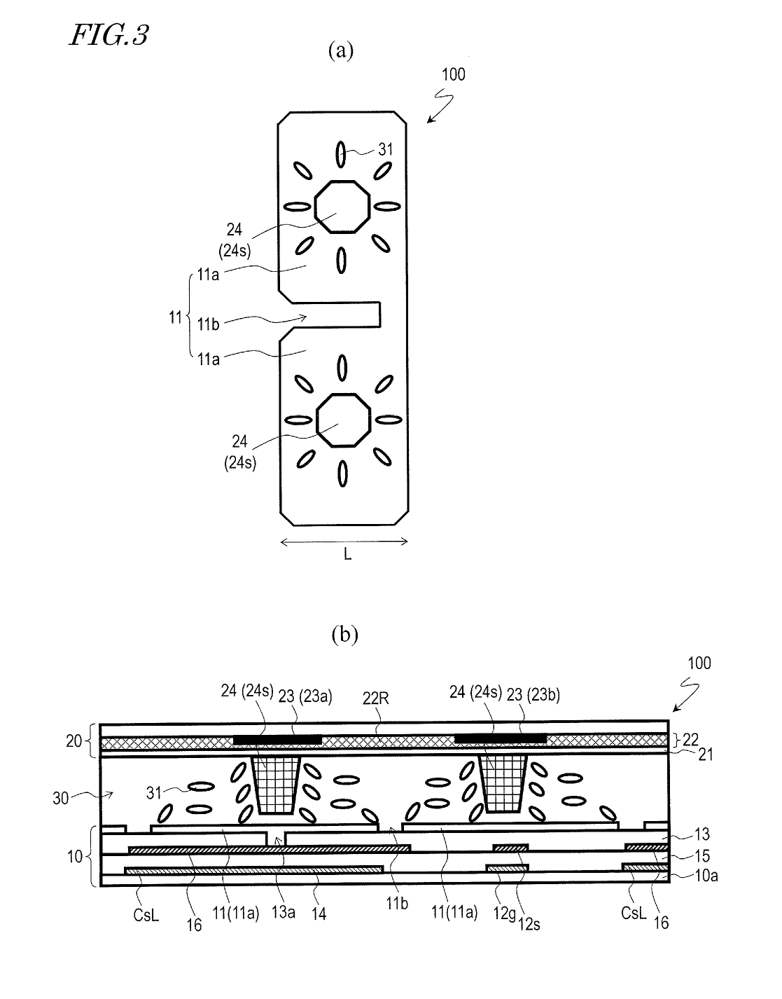

In this liquid crystal display device 100, when a voltage is applied between the pixel electrode 11 and the counter electrode 21 in each pixel, a plurality of liquid crystal domains with axisymmetric alignment are produced as shown in FIGS. 3(a) and 3(b). The plurality of (e.g., two in this embodiment) liquid crystal domains are formed in association with a plurality of (e.g., two in this embodiment) subpixel electrodes 11a. Each of those liquid crystal domains is formed under the alignment controlling force applied by an oblique electric field to be generated in the vicinity of the edges of each subpixel electrode 11a when the voltage is applied. Such an electric field causes the liquid crystal molecules 31 to fall perpendicularly to those edges.

In this embodiment, the length L of the pixel electrode 11 as measured along its shorter sides (see FIG. 3(a)) is set to fall within a predetermined range. Specifically, the length L of the pixel electrode 11 as measured along its shorter sides is equal to or smaller than 35 μm.

Also, in this liquid crystal display device 100, each of the plurality of columnar spacers 24 is arranged in a region corresponding to substantially the center of its associated liquid crystal domain and functions as an alignment controlling projection which induces axisymmetric alignment of liquid crystal molecules in the liquid crystal domain. As a result, the axisymmetric alignment of each liquid crystal domain is stabilized by the alignment controlling force of those columnar spacers 24 that function as alignment controlling projections (i.e., thanks to the anchoring effect produced by their surface). In the pixel shown in FIG. 1 and other drawings, each of the two sub-spacers 24s functions as an alignment controlling projection.

It should be noted that the relative dielectric constant of the columnar spacers 24 is suitably lower than the relative dielectric constant of the liquid crystal layer 30 (i.e., that of the liquid crystal material that makes the liquid crystal layer 30) in order to prevent the tilt direction of the liquid crystal molecules 31 defined by the shape of the side surface of the columnar spacers 24 and the direction in which the electric field is going to tilt the liquid crystal molecules 31 when a voltage is applied to the liquid crystal layer 30 from becoming opposite from each other.

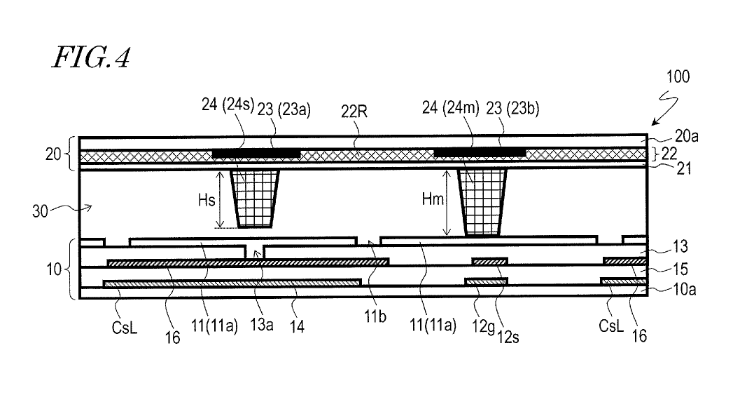

The plurality of pixels of this liquid crystal display device 100 includes some pixels in which the main spacers function as alignment controlling projections. For example, in the pixel shown in FIG. 4, one of the two columnar spacers 24 is a sub-spacer 24s and the other is a main spacer 24m. The height Hs of the sub-spacer 24s is less than the height Hm of the main spacer 24m. It should be noted that these heights Hs and Hm of the main and sub-spacers 24m and 24s mean the heights of the respective tops of the main and sub-spacers 24m and 24s as measured with respect to a certain reference plane which is defined by the surface of the counter electrode 21 in this embodiment (i.e., the distances from that reference plane to the tops of those spacers).

If the arrangement density of those columnar spacers 24 is represented on an area basis, the main spacers 24m may have an arrangement density of 0.14 to 0.20% while the sub-spacers 24s may have an arrangement density of 0.90 to 10.0%. That is why in a lot of pixels, both of the two columnar spacers 24 are sub-spacers 24s. And in some pixels, one of the two columnar spacers 24 is a sub-spacer 24s and the other columnar spacer 24 is a main spacer 24m. Consequently, in each pixel, the sub-spacer 24s functions as an alignment controlling projection for at least some of the plurality of liquid crystal domains.

In this embodiment, the height Hs of the sub-spacers 24s is set so as to fall within a predetermined range with respect to the height Hm of the main spacers 24m. Specifically, the height Hs of the sub-spacers Hs is 75 to 92% of the height Hm of the main spacers 24m (i.e., 0.75 Hm≦Hs≦510.92 Hm is satisfied). For example, if the height Hm of the main spacers 24m is 3.6 μm (i.e., if the thickness of the liquid crystal layer 30 (or the cell gap) is 3.6 μm), the height Hs of the sub-spacers 24s is approximately 2.7 to 3.3 μm. Also, if the height Hm of the main spacers 24m is 3.1 μm (i.e., if the thickness of the liquid crystal layer 30 (or the cell gap) is 3.1 μm), the height Hs of the sub-spacers 24s is approximately 2.3 to 2.9 μm.

Also, in this embodiment, the contact hole 13a is arranged so as to overlap with an alignment controlling projection (i.e., the sub-spacer 24s) associated with one of the plurality of liquid crystal domains (e.g., one of the two liquid crystal domains in this example) when viewed along a normal to the display screen. Furthermore, the TFT 12 is arranged so as to overlap with an alignment controlling projection (i.e., the sub-spacer 24s or the main spacer 24m) associated with another one of the plurality of liquid crystal domains (e.g., the other of the two liquid crystal domains in this example) when viewed along a normal to the display screen.

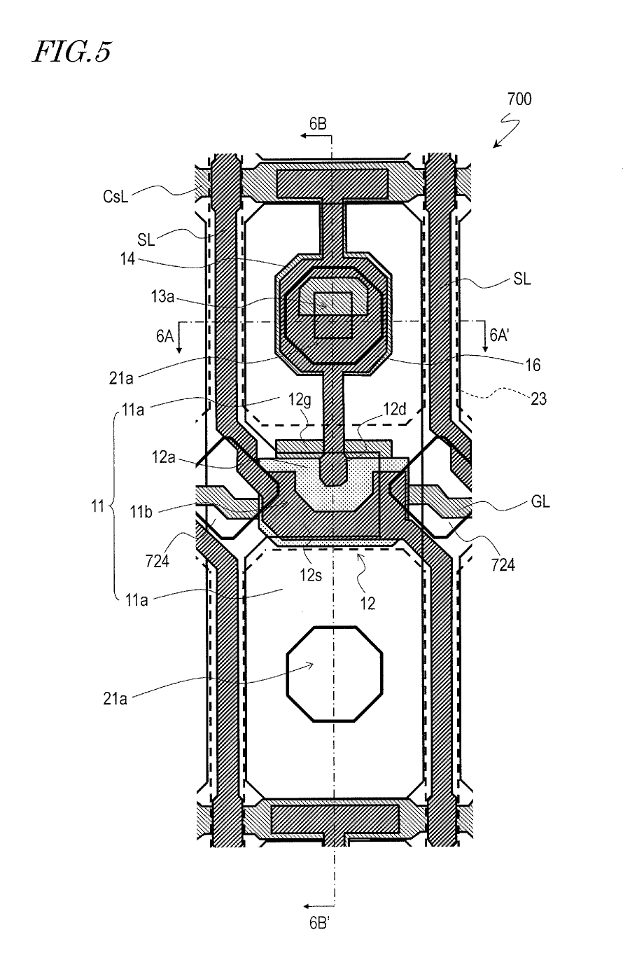

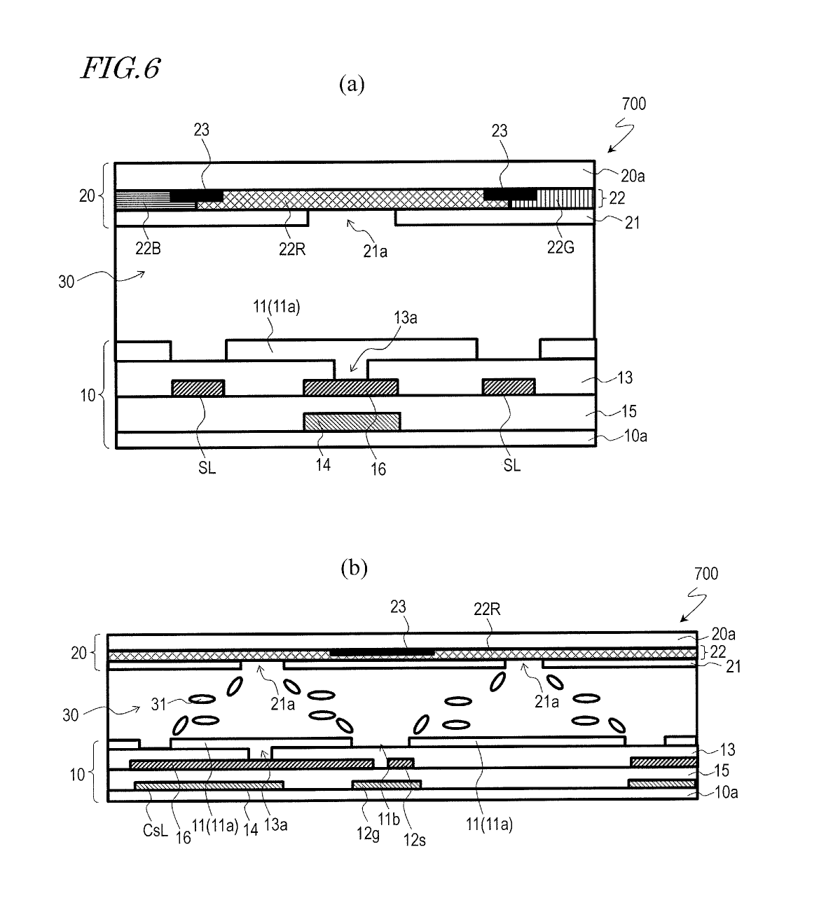

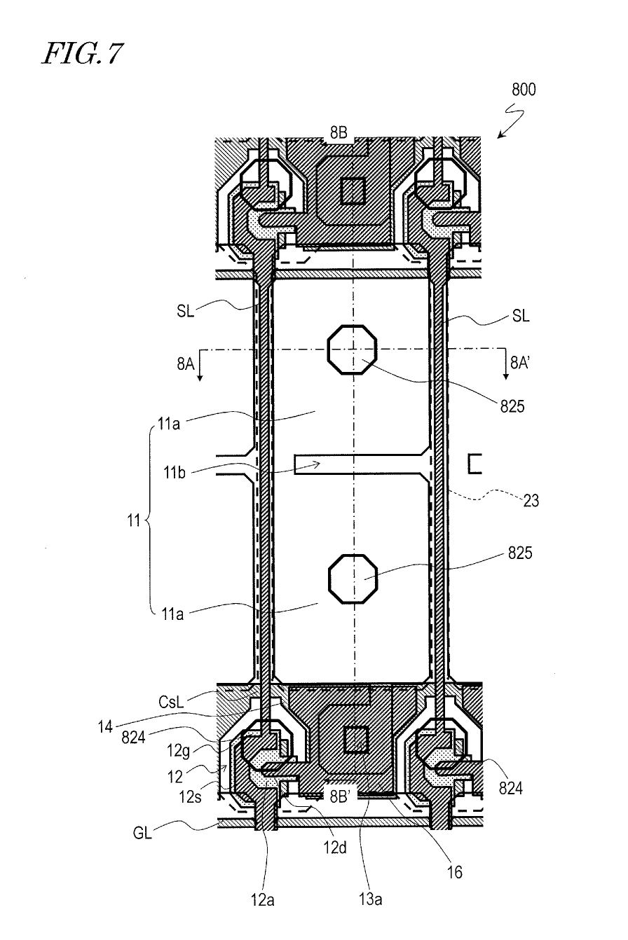

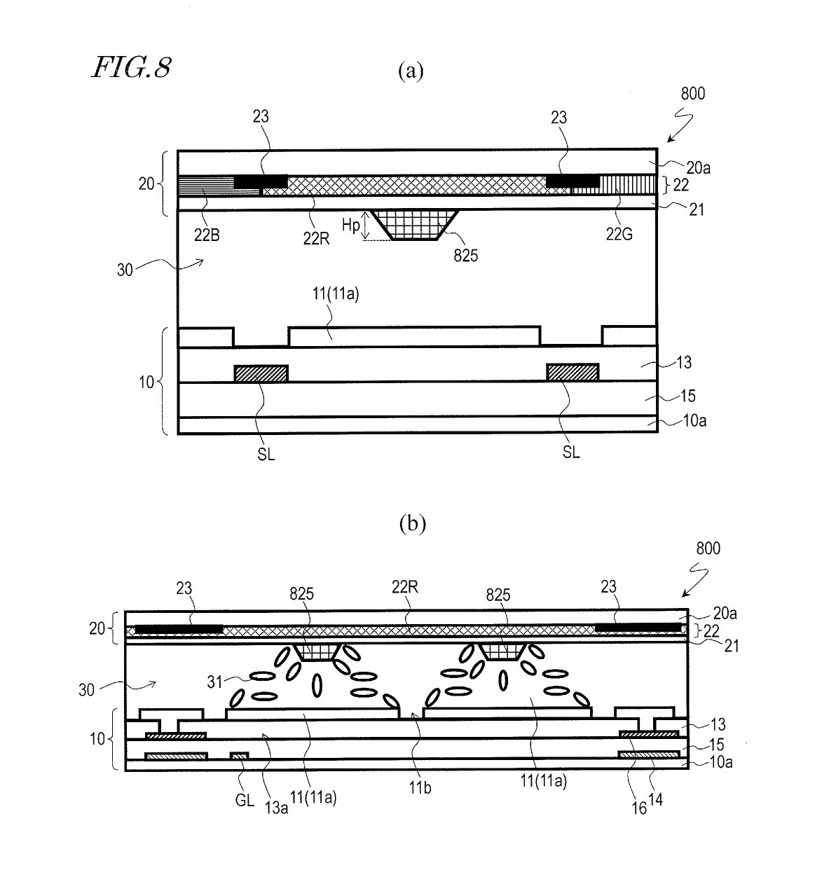

By adopting the configuration described above, the liquid crystal display device 100 of this embodiment can minimize the trace unevenness. The reason will be described with reference to a liquid crystal display device 700 as a comparative example shown in FIGS. 5 and 6 and a liquid crystal display device 800 as another comparative example shown in FIGS. 7 and 8.

FIG. 5 is a plan view schematically illustrating a liquid crystal display device 700 as a comparative example. FIGS. 6(a) and 6(b) are cross-sectional views as respectively viewed on the planes 6A-6A′ and 6B-6B′ shown in FIG. 5. FIG. 7 is a plan view schematically illustrating a liquid crystal display device 800 as another comparative example. FIGS. 8(a) and 8(b) are cross-sectional views as respectively viewed on the planes 8A-8A′ and 8B-8B′ shown in FIG. 7.

In the liquid crystal display device 700 of the comparative example shown in FIGS. 5 and 6, the counter substrate 20 has no alignment controlling projections in a region corresponding to substantially the center of each liquid crystal domain, which is a difference from the liquid crystal display device 100 of this embodiment. The counter substrate 20 of the liquid crystal display device 700 also includes a plurality of columnar spacers 724, which are arranged so as not to overlap with the pixel electrodes 11 and are not located in such a region corresponding to substantially the center of each liquid crystal domain.

In the liquid crystal display device 700, a hole 21a which has been cut through the counter electrode 21 is located in a region corresponding to substantially the center of each liquid crystal domain and functions as an alignment control structure. When a voltage is applied between the pixel electrode 11 and the counter electrode 21, an oblique electric field is generated in the vicinity of the edge of the hole 21 and the axisymmetric alignment of the liquid crystal domain gets stabilized under the alignment controlling force produced by this oblique electric field.

On the other hand, in the liquid crystal display device 800 of the comparative example shown in FIGS. 7 and 8, the counter substrate 20 does include an alignment controlling projection 825 in a region corresponding to substantially the center of each liquid crystal domain. However, the alignment controlling projection 825 of this liquid crystal display device 800 has too small a height HP to function as a main spacer or a sub-spacer. In the following description, such an alignment controlling projection 825 that does not function as a main spacer or a sub-spacer will be referred to herein as a “rivet”.

In this liquid crystal display device 800, the axisymmetric alignment of the liquid crystal domains gets stabilized under the alignment controlling force produced by the rivets 825 (i.e., thanks to the anchoring effect produced by their surface). If the liquid crystal layer 30 has a thickness of approximately 3 to 4 μm, the rivets 825 may have a height Hp of approximately 1.4 μm, for example.

As can be seen, in the liquid crystal display devices 700 and 800 of these comparative examples, a hole 21a and a rivet 825 are provided as their respective alignment control structures for the counter electrode 21. However, if the liquid crystal display device 700 or 800 is used with stress applied intentionally onto its surface as in smart phones and tablet display devices which have become more and more popular recently, the hole 21a or rivet 825 of the counter electrode 21 would be unable to exert sufficient alignment controlling force to the liquid crystal molecules 31 in the liquid crystal domains and stabilize the axisymmetric alignment sufficiently. Consequently, the trace unevenness would arise.

The trace unevenness arises while a voltage is being applied to the liquid crystal layer 30. In the vertical alignment liquid crystal layer 30, the liquid crystal molecules 31 are vertically aligned orderly while no voltage is being applied. That is why even if the alignment is disturbed to some extent with the pressure applied onto the surface of the panel by the user's finger, for example, the liquid crystal molecules will recover their original alignment state relatively quickly. On the other hand, while the alignment direction of the liquid crystal molecules 31 is being controlled by applying a voltage to the liquid crystal layer 30, the alignment is so disturbed that if the alignment is further disturbed with the pressure applied onto the surface of the panel by the user's finger, for example, the liquid crystal molecules could stay disturbed even after the stress applied is removed. This is the so-called “trace unevenness” phenomenon. The higher the voltage applied to the liquid crystal layer 30 is, the more noticeable the trace unevenness will get.

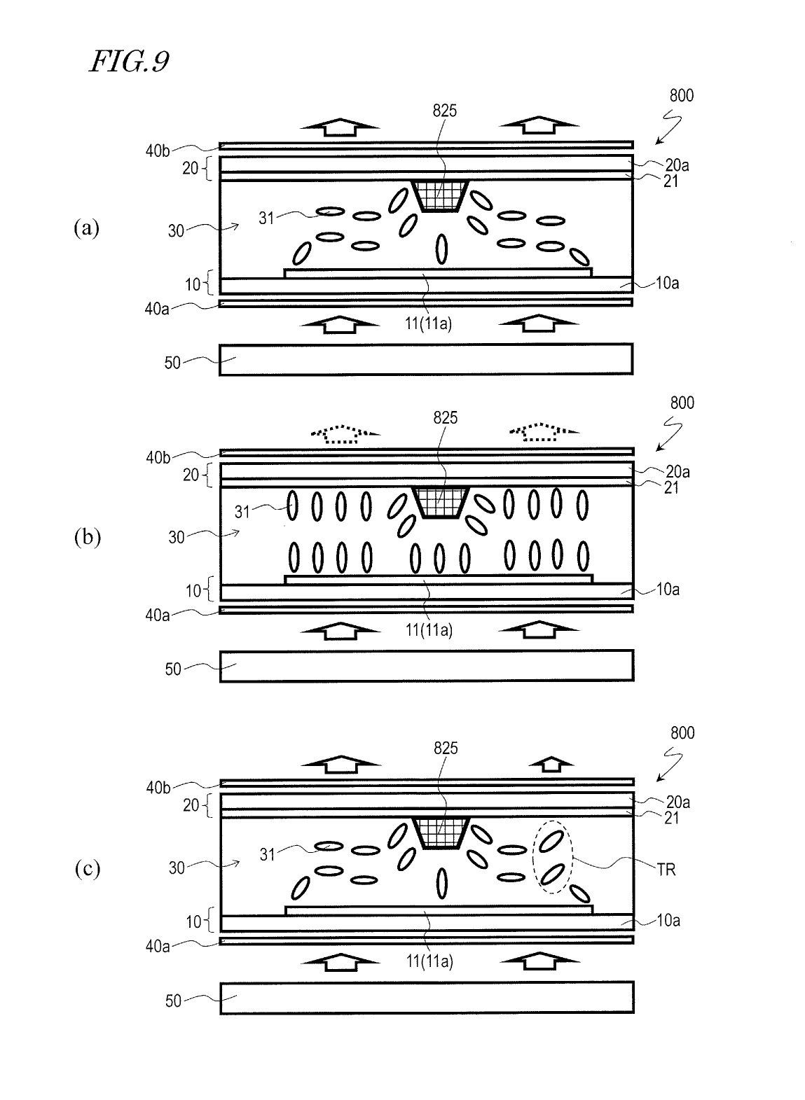

Hereinafter, it will be described with reference to FIGS. 9(a), 9(b) and 9(c) exactly how such trace unevenness arises in the liquid crystal display device 800 of the comparative example, for instance. FIG. 9(a) illustrates an alignment state in the white display state, FIG. 9(b) illustrates an alignment state in the black display state, and FIG. 9(c) illustrates an alignment state in which the trace unevenness has occurred in the white display state. In FIGS. 9(a), 9(b) and 9(c), shown are two polarizers 40a and 40b which are arranged outside of the LCD panel and a backlight 50 which is arranged behind the LCD panel.

As shown in FIG. 9(a), the light emitted from the backlight 50 enters the LCD panel through the polarizer 40a on the rear side, gets transmitted and modulated through the liquid crystal layer 30 in the axisymmetrically aligned state, and then goes out of the LCD panel through the polarizer 40b on the viewer side. In this manner, a white display operation is conducted.

On the other hand, as shown in FIG. 9(b), if the light that has entered the LCD panel through the polarizer 40a on the rear side is transmitted through the liquid crystal layer 30 in the vertically aligned state, then the light is hardly modulated and does not go out of the LCD panel through the polarizer 40b on the viewer side. In this manner, a black display operation is conducted.

If the trace unevenness has occurred, some liquid crystal molecules 31 stay oriented in a direction that does not agree with the direction defined by the alignment controlling force exerted by the alignment controlling projection (i.e., alignment control structure) 825 in some region of the liquid crystal layer 30 in the pixel as shown in FIG. 9(c). In such a region (e.g., the region TR shown in FIG. 9(c)), the optical transmittance is different from the transmittance in the other regions, and therefore, display unevenness is recognized there.

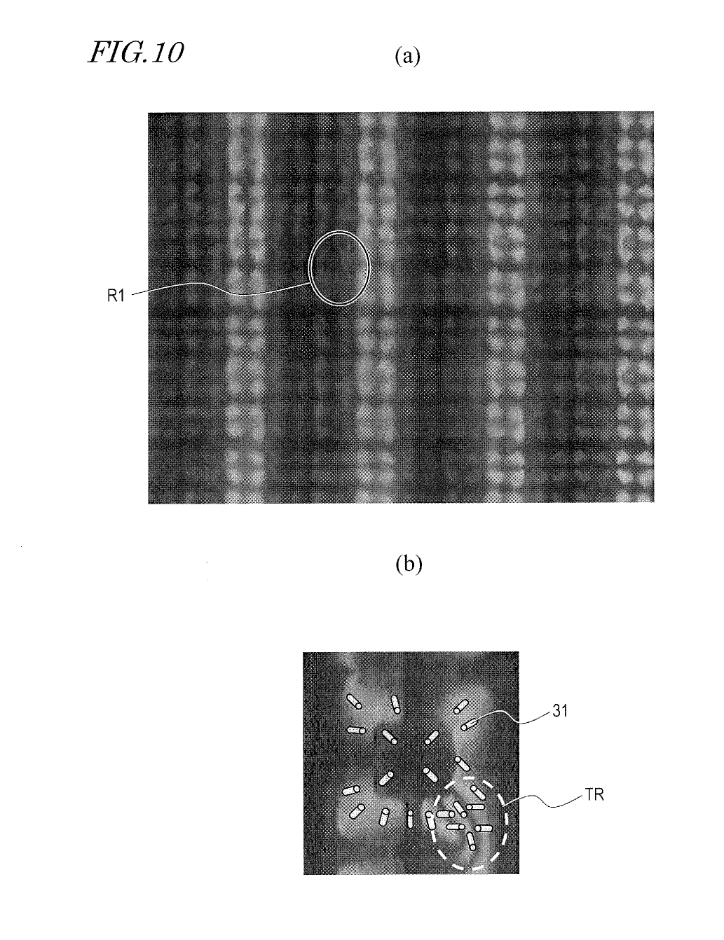

FIG. 10(a) is a micrograph of the liquid crystal display device in the white display state in which trace unevenness has occurred. In this case, the polarizers 40a and 40b are linear polarizers. For example, in the region R1 shown in FIG. 10(a), dispersion in transmittance manifests itself as unevenness. FIG. 10(b) illustrates, on a larger scale, a pixel in which the trace unevenness has occurred. In FIG. 10(b), also shown are the alignment directions of the liquid crystal molecules 31. As can be seen from FIG. 10(b), in the region TR in which the trace unevenness has occurred, the liquid crystal molecules 31 are oriented in a direction that does not agree with the axisymmetric alignment direction of the liquid crystal domain.

As can be seen, in the liquid crystal display devices 700 and 800 of the comparative examples, the hole 21a or rivet 825 of the counter electrode 21 does not have alignment controlling force that is strong enough to eliminate such trace unevenness.

In the liquid crystal display device 100 of this embodiment, the sub-spacer 24s functioning as an alignment controlling projection (or the main spacer 24m in some liquid crystal domains) can stabilize the axisymmetric alignment in each pixel as described above. Since the sub-spacer 24s (and the main spacer 24m) has been formed to be higher than the rivet 825 that the liquid crystal display device 800 of the comparative example has, the sub-spacer 24s can naturally exert the alignment controlling force on a larger number of liquid crystal molecules 31 than the rivet 825 does. That is to say, the sub-spacer 24s of this liquid crystal display device 100 can have sufficiently strong alignment controlling force. Consequently, the liquid crystal display device 100 of this embodiment can stabilize the axisymmetric alignment sufficiently and can suppress the trace unevenness.

In addition, since the liquid crystal display device 100 of this embodiment uses the sub-spacer 24s (or the main spacer 24m) as an alignment controlling projection, there is no need to perform an additional process step of forming alignment controlling projections when the counter substrate 20 is made. On top of that, since there is no need to adopt the PSA technology, the process step of forming an alignment sustaining layer (i.e., the PSA process) does not have to be performed while the LCD panel is being fabricated. As a result, the increase in the cost and time of the manufacturing process that would be involved with the PSA process can be avoided.

From the standpoint of exerting sufficient alignment controlling force, the height Hs of the sub-spacer 24s is suitably 75% or more of the height Hm of the main spacer 24m. Also, to make the sub-spacer 24s perform its expected function fully, the height Hs of the sub-spacer 24s is suitably 92% or less of the height Hm of the main spacer 24m. For these reasons, the height Hs of the sub-spacer 24s is suitably 75 to 92% of the height Hm of the main spacer 24m as in this embodiment.

If the main spacer 24m and the sub-spacer 24s are both made of a photosensitive resin, their heights Hm and Hs could deviate by approximately ±0.2 μm at maximum from their designed values due to variations in various manufacturing process conditions. For that reason, the difference between the designed heights Hm and Hs of the main and sub-spacers 24m and 24s is suitably at least equal to 0.4 μm. Considering this point, it can be said that in order to exert sufficient alignment controlling force, the sub-spacer 24s is suitably lower by approximately 0.5 μm than the main spacer 24m, for example.

Furthermore, the length L of the pixel electrode 11 as measured along its shorter sides is suitably equal to or smaller than 35 μm as in this embodiment. In a relatively small pixel in which the length L of the pixel electrode 11 as measured along its shorter sides is equal to or smaller than 35 μm, the columnar spacers 24 functioning as alignment controlling projections can easily exert alignment controlling force to the majority of the liquid crystal domains. As a result, the trace unevenness can be suppressed with even more certainty.

Also, for the reasons to be described below, the TFT 12 is suitably arranged so as to overlap with a columnar spacer 24 functioning as an alignment controlling projection when viewed along a normal to the display screen. In the vicinity of the columnar spacer 24, the liquid crystal molecules 31 are aligned substantially perpendicularly to the surface of the columnar spacer 24 even when no voltage is applied, and therefore, light may leak to cause a decrease in contrast ratio in some cases. For that reason, the region with the columnar spacer 24 is suitably shielded from light. Thus, if the TFT 12 is arranged so as to overlap with the columnar spacer 24 functioning as an alignment controlling projection, the region with the columnar spacer 24 can also be shielded from light with the TFT shielding portion 23b to shield the TFT 12 from light. As a result, the percentage of a portion of the entire pixel contributing to the display operation (i.e., its aperture ratio) can be increased and a brighter image can be displayed.

For the same reason, the contact hole 13a is suitably arranged so as to overlap with a columnar spacer 24 functioning as an alignment controlling projection when viewed along a normal to the display screen. If the contact hole 13a is arranged so as to overlap with the columnar spacer 24 functioning as an alignment controlling projection, the region with the columnar spacer 24 can also be shielded from light with the contact hole shielding portion 23a to shield the contact hole 13a from light. As a result, the percentage of a portion of the entire pixel contributing to the display operation (i.e., its aperture ratio) can be increased and a brighter image can be displayed.

The present inventors actually made sample liquid crystal display devices 100 of this embodiment (as Examples #1 through #6) to see whether low-temperature bubbling and trace unevenness occurred or not. The results of evaluation will be described below. For the purpose of comparison, the present inventors also made sample liquid crystal display devices 700 and 800 of the comparative examples (as Comparative Example #1 and Comparative Examples #2 through #6, respectively) to perform similar evaluations. The results will also be described below.

The following Table 1 shows the height of the main spacers 24m (corresponding to the thickness of the liquid crystal layer 30), the type and height of the alignment control structure, the ratio of the height of the alignment control structure to that of the main spacers 24m, the size of the alignment control structure, the arrangement density of the main spacers 24m, and the (vertical and horizontal) pixel sizes with respect to each of Examples #1 through #6 and Comparative Examples #1 through #6. Also, the following Table 2 shows the white voltage, the black voltage, whether the PSA treatment was carried out or not, whether low-temperature bubbling occurred or not, and whether trace unevenness occurred or not with respect to each of Examples #1 through #6 and Comparative Examples #1 through #6.

To determine whether low-temperature bubbling occurred or not, the LCD panel was observed right after a pachinko ball was dropped once from a height of 10 cm at the lower limit temperature of the keeping temperature range specified for that product. The open circle ◯ indicates that the low-temperature bubbling could be suppressed.

On the other hand, to determine whether trace unevenness occurred or not, the decision was made whether the trace disappeared or not after a strong pressure had been applied by a fingertip on the screen in the white display state. The open circle ◯ indicates that trace unevenness could be suppressed. The cross X indicates that trace unevenness occurred. And the open triangle Δ indicates that trace unevenness could be basically suppressed but there was only little margin with respect to the trace unevenness (i.e., trace unevenness occurred depending on dispersion in specification during the manufacturing process of the LCD panel).

TABLE 1

| | Main | | | | | | | |
|---|---|---|---|---|---|---|---|---|
| | spacer | Alignment control structure | | | | Main spacer | Pixel sizes | |
| | height | | Height | Height | Size | arrangement | Vertical | Horizontal |
| | (μm) | Type | (μm) | ratio | (μm) | density | (μm) | (μm) |
| Example | 3.6 | Sub-spacer | 2.9 | 80.6% | 12.0 | 0.14% | 46.5 | 28.5 |
| 1 | | | | | | | | |
| Example | 3.6 | Sub-spacer | 3.1 | 86.1% | 12.0 | 0.14% | 46.5 | 28.5 |
| 2 | | | | | | | | |
| Example | 3.6 | Sub-spacer | 3.3 | 91.7% | 12.0 | 0.14% | 46.5 | 28.5 |
| 3 | | | | | | | | |
| Example | 3.6 | Sub-spacer | 3.1 | 86.1% | 12.0 | 0.14% | 41 | 27 |
| 4 | | | | | | | | |
| Example | 3.6 | Sub-spacer | 3.1 | 86.1% | 12.0 | 0.20% | 34.5 | 66.75 |
| 5 | | | | | | | | |
| Example | 3.6 | Sub-spacer | 3.1 | 86.1% | 12.0 | 0.20% | 40.5 | 55.5 |
| 6 | | | | | | | | |
| Cmp. | 3.6 | Counter | 0 | 0% | 15.0 | 0.14% | 41 | 27 |
| Ex. 1 | | electrode's | | | | | | |
| | | hole | | | | | | |
| Cmp. | 3.1 | Rivet | 1.45 | 46.8% | 15.0 | 0.17% | 66.75 | 52 |
| Ex. 2 | | | | | | | | |
| Cmp. | 3.1 | Rivet | 1.45 | 46.8% | 15.0 | 0.14% | 102 | 41 |
| Ex. 3 | | | | | | | | |
| Cmp. | 3.6 | Rivet | 1.45 | 40.3% | 15.0 | 0.20% | 48.6 | 51 |
| Ex. 4 | | | | | | | | |
| Cmp. | 3.6 | Rivet | 1.45 | 40.3% | 15.0 | 0.17% | 34.5 | 52 |
| Ex. 5 | | | | | | | | |
| Cmp. | 3.6 | Rivet | 1.45 | 40.3% | 15 × 25 | 0.16% | 78.25 | 50.5 |
| Ex. 6 | | | | | | | | |

TABLE 2

| | White | Black | | Low-temperature | Trace | |
|---|---|---|---|---|---|---|
| | voltage | voltage | PSA | bubbling | unevenness | |
| | (V) | (V) | treatment | evaluation | evaluation | Note |
| Example | 5.0 | 0.0 | NO | ∘ | ∘ | 3.8 |
| 1 | | | | | | inch |
| | | | | | | WVGA |
| Example | 5.0 | 0.0 | NO | ∘ | ∘ | 3.8 |
| 2 | | | | | | inch |
| | | | | | | WVGA |
| Example | 5.0 | 0.0 | NO | ∘ | ∘ | 3.8 |
| 3 | | | | | | inch |
| | | | | | | WVGA |
| Example | 5.0 | 0.0 | NO | ∘ | ∘ | 3.7 |
| 4 | | | | | | inch |
| | | | | | | WVGA |
| Example | 4.7 | 0.0 | NO | ∘ | ∘ | 3.15 |
| 5 | | | | | | inch |
| | | | | | | 460 K |
| Example | 4.7 | 0.0 | NO | ∘ | Δ | 3 inch |
| 6 | | | | | | 460 K |
| Cmp. | 5.0 | 0.0 | NO | ∘ | x | 4.3 |
| Ex. 1 | | | | | | inch |
| | | | | | | qHD |
| Cmp. | 4.8 | 0.0 | YES | ∘ | ∘ | 3.2 |
| Ex. 2 | | | | | | inch |
| | | | | | | WQVGA |
| Cmp. | 5.1 | 0.0 | YES | ∘ | ∘ | 3.2 |
| Ex. 3 | | | | | | inch |
| | | | | | | HVGA |
| Cmp. | 5.0 | 0.0 | NO | ∘ | x | 2.8 |
| Ex. 4 | | | | | | inch |
| | | | | | | QVGA |
| Cmp. | 4.8 | 0.0 | NO | ∘ | x | 10.8 |
| Ex. 5 | | | | | | inch |
| | | | | | | FWXGA |
| Cmp. | 4.8 | 0.0 | NO | ∘ | x | 10.1 |
| Ex. 6 | | | | | | inch |
| | | | | | | FWXGA |

As can be seen from Tables 1 and 2, low-temperature bubbling could be suppressed in each of Examples #1 through #6 and Comparative Examples #1 through #6. However, trace unevenness occurred in Comparative Example 1 in which a hole 21a had been cut through the counter electrode 21 as an alignment control structure and in Comparative Examples #4 to #6 in which a rivet 825 was provided as an alignment control structure. In Comparative Examples #2 and #3, even though the rivet 825 was provided as an alignment control structure, trace unevenness could be suppressed, because PSA treatment had been carried out in Comparative Examples #2 and #3.

On the other hand, in Examples #1 through #6 in which sub-spacers 24s were provided as alignment control structures, no PSA treatment was carried out but trace unevenness could be suppressed. Also, in each of Examples #1 through #6, the height Hs of the sub-spacers 24s fell within the range of 75 to 92% of the height Hm of the main spacers 24m. Thus, it can be seen that the height Hs of the sub-spacers 24s is suitably 75 to 92% of the height Hm of the main spacers 24m. Furthermore, in Example #6 in which the length L of the pixel electrode 11 as measured along its shorter sides was greater than 35 μm, there was little margin with respect to the trace unevenness. Meanwhile, in Examples #1 through #5 in which the length L of the pixel electrode 11 as measured along its shorter sides was equal to or smaller than 35 μm, such a problem did not arise. Thus, it can be seen that the length L of the pixel electrode 11 as measured along its shorter sides is suitably equal to or smaller than 35 μm.

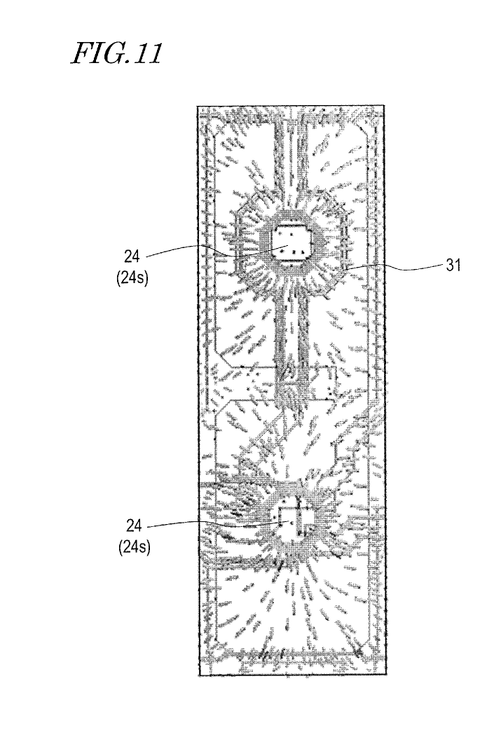

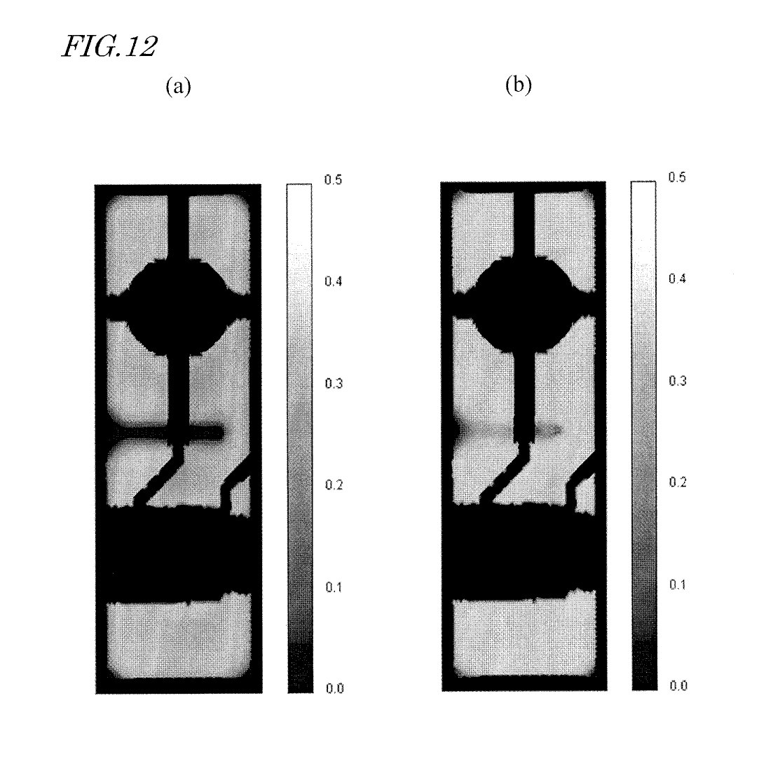

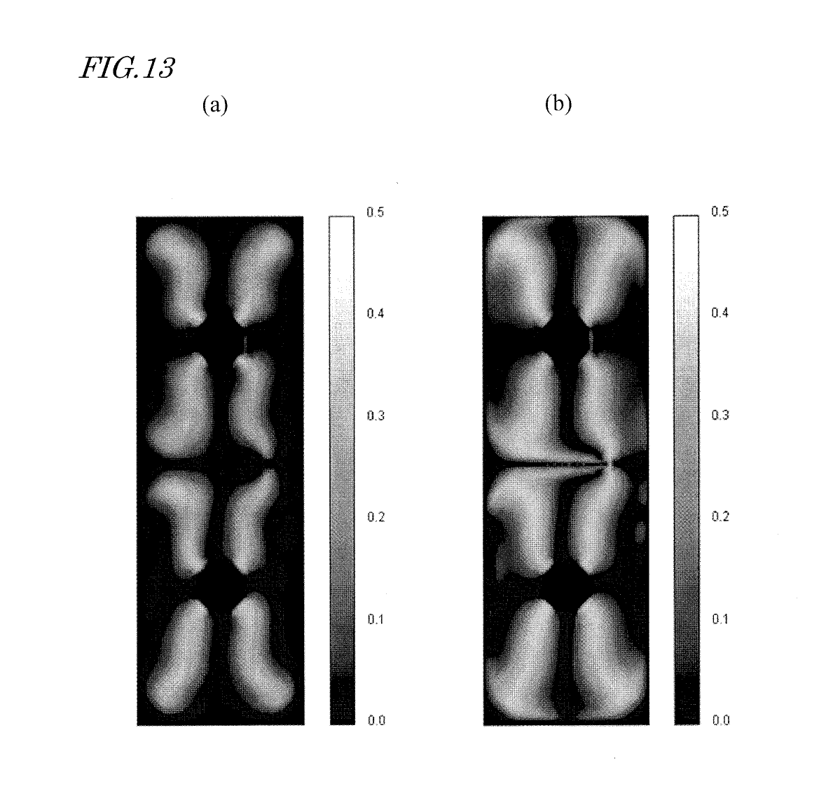

FIG. 11 shows the result of a simulation that was carried out on the liquid crystal display device 100 of this embodiment (i.e., having the specifications of Example #2) to predict the alignment of the liquid crystal molecules 31 when a voltage is applied to the liquid crystal layer 30. FIGS. 12 and 13 show the results of simulations that were carried out on the liquid crystal display device 100 of this embodiment (i.e., having the specifications of Example #2) to predict the transmittances of a pixel when a voltage is applied to the liquid crystal layer 30. Specifically, FIGS. 12(a) and 12(b) represent a situation where circular polarizers are provided as a pair of polarizers outside of the LCD panel. On the other hand, FIGS. 13(a) and 13(b) represent a situation where linear polarizers are provided as a pair of polarizers outside of the LCD panel. Also, FIGS. 12(a) and 13(a) represent a situation where a voltage of 3.5 V is being applied to the liquid crystal layer 30. Meanwhile, FIGS. 12(b) and 13(b) represent a situation where a voltage of 5 V is being applied to the liquid crystal layer 30.

As can be seen from FIG. 11, FIGS. 12(a) and 12(b), and FIGS. 13(a) and 13(b), liquid crystal domains with a stabilized axisymmetric alignment that had been hardly disturbed were formed around the columnar spacers 24 (i.e., around the sub-spacers 24s).

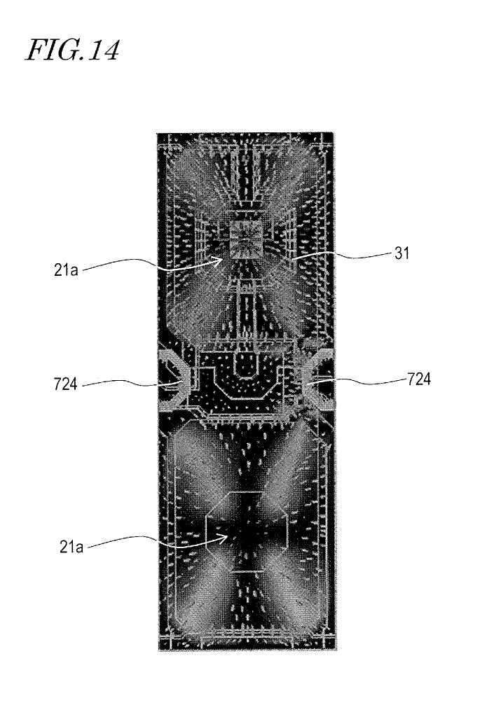

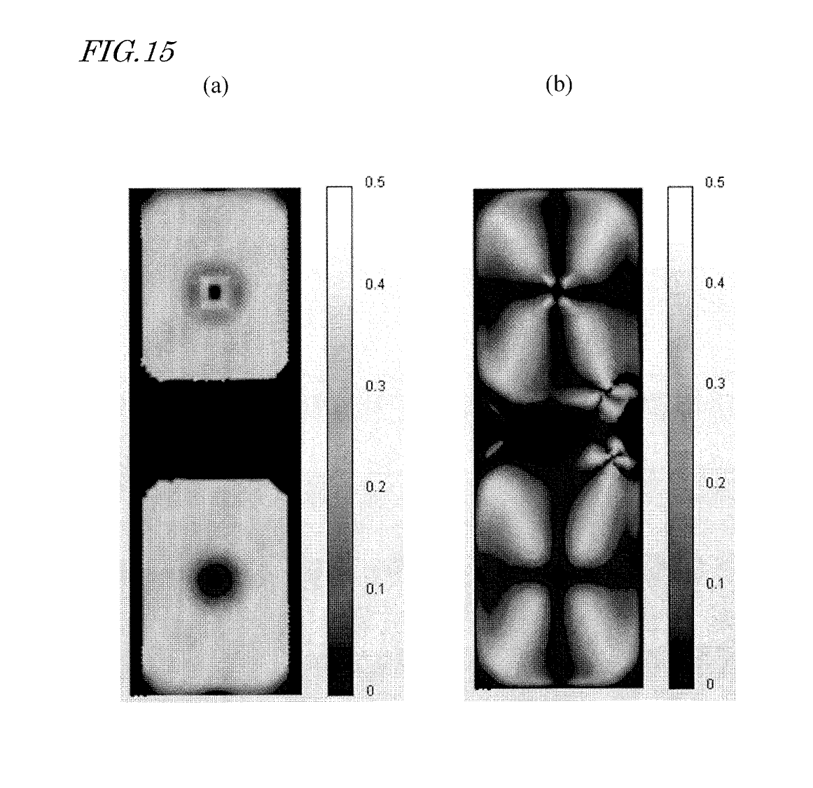

FIG. 14 shows the result of a simulation that was carried out on the liquid crystal display device 700 of a comparative example (i.e., having the specifications of Comparative Example #1) to predict the alignment of the liquid crystal molecules 31 when a voltage is applied to the liquid crystal layer 30. FIGS. 15(a) and 15(b) show the results of simulations that were carried out on the liquid crystal display device 700 of the comparative example (i.e., having the specifications of Comparative Example #1) to predict the transmittances of a pixel when a voltage is applied to the liquid crystal layer 30. Specifically, FIG. 15(a) illustrates a situation where circular polarizers are provided as a pair of polarizers outside of the LCD panel. On the other hand, FIGS. 15(b) represent a situation where linear polarizers are provided as a pair of polarizers outside of the LCD panel. Also, FIGS. 15(a) and 15(b) represent a situation where a voltage of 5 V is being applied to the liquid crystal layer 30.

As can be seen from FIG. 14 and FIGS. 15(a) and 15(b), liquid crystal domains had been produced but their alignments had been disturbed by the pressure applied by a fingertip between the notched portion 11b of the pixel electrode 11 and the contact hole 13a. It can also be seen that the alignments had also been disturbed in the vicinity of columnar spacers 24 on the right-hand side (i.e., sub-spacers 24s) located over the bridge portion connecting the subpixel electrodes 11a together.

In the embodiments described above, when a voltage is applied between the pixel electrode 11 and the counter electrode 21, a plurality of liquid crystal domains are supposed to be produced in each pixel. However, this is just an example of the present invention.

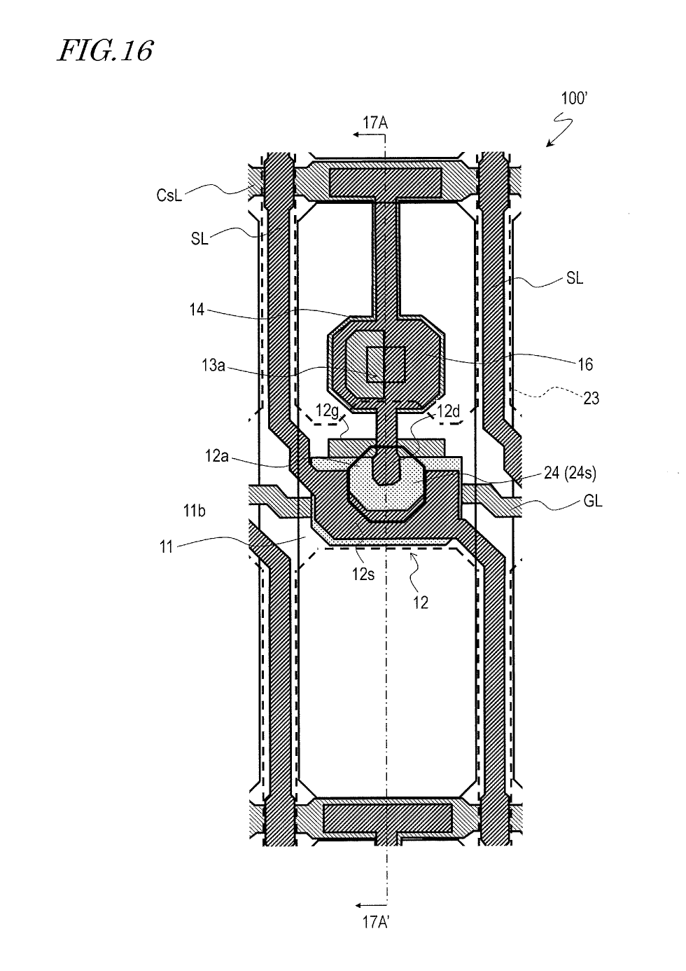

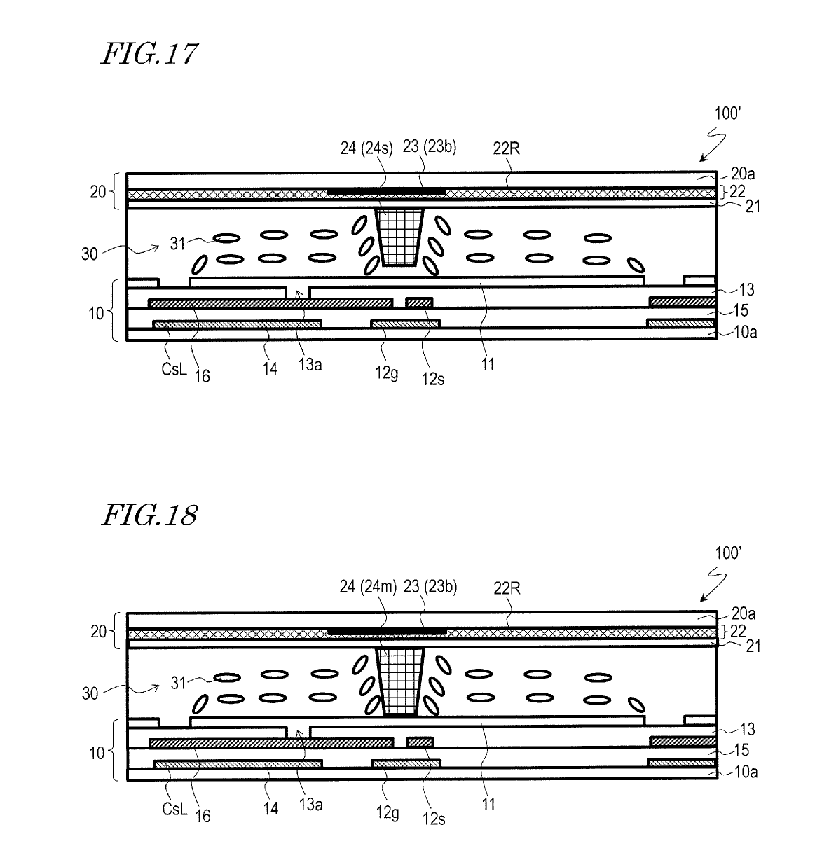

FIGS. 16 and 17 illustrate another liquid crystal display device 100′ according to this embodiment. Specifically, FIG. 16 is a plan view schematically illustrating the liquid crystal display device 100′ and FIG. 17 is a cross-sectional view as viewed on the plane 17A-17A′ shown in FIG. 16.

As shown in FIGS. 16 and 17, in this liquid crystal display device 100′, the pixel electrode 11 has no notched portion and is not divided into a plurality of subpixel electrodes. A columnar spacer 24 (e.g., a sub-spacer 24s in the pixel shown in FIGS. 16 and 17) is arranged in a region on the counter substrate 20 corresponding to substantially the center of the pixel electrode 11.

In this liquid crystal display device 100′, when a voltage is applied between the pixel electrode 11 and the counter electrode 21, a single liquid crystal domain is produced in each pixel as shown in FIG. 17. The axisymmetric alignment of this liquid crystal domain is stabilized by the columnar spacer 24 which functions as an alignment controlling projection.

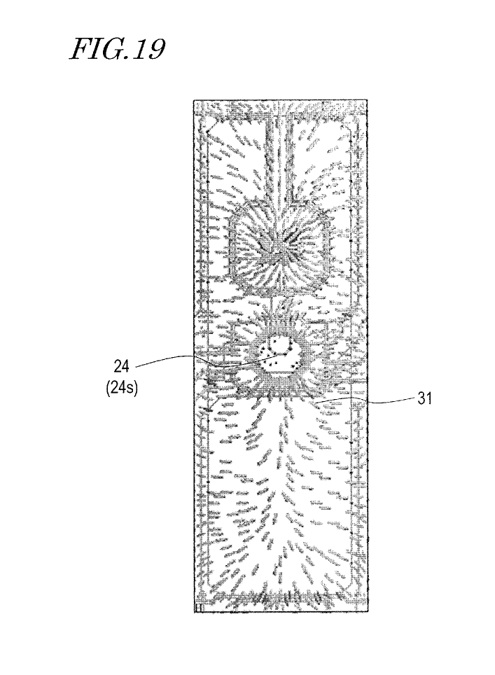

It should be noted that the plurality of pixels of this liquid crystal display device 100′ also includes some pixels in which the main spacer 24m functions as an alignment controlling projection as shown in FIG. 18. That is to say, the main spacer 24m functions as an alignment controlling projection in some of the plurality of pixels, and the sub-spacer 24s functions as an alignment controlling projection in the other pixels.

Even in the liquid crystal display device 100′ shown in FIGS. 16 to 18, the sub-spacer 24s (or the main spacer 24m) functioning as an alignment controlling projection also stabilizes the axisymmetric alignment, and therefore, can suppress the trace unevenness.

For the same reason as what has already been described for the liquid crystal display device 100, the TFT 12 is suitably arranged as shown in FIG. 16 so as to overlap with the columnar spacer 24 functioning as an alignment controlling projection when viewed along a normal to the display screen.

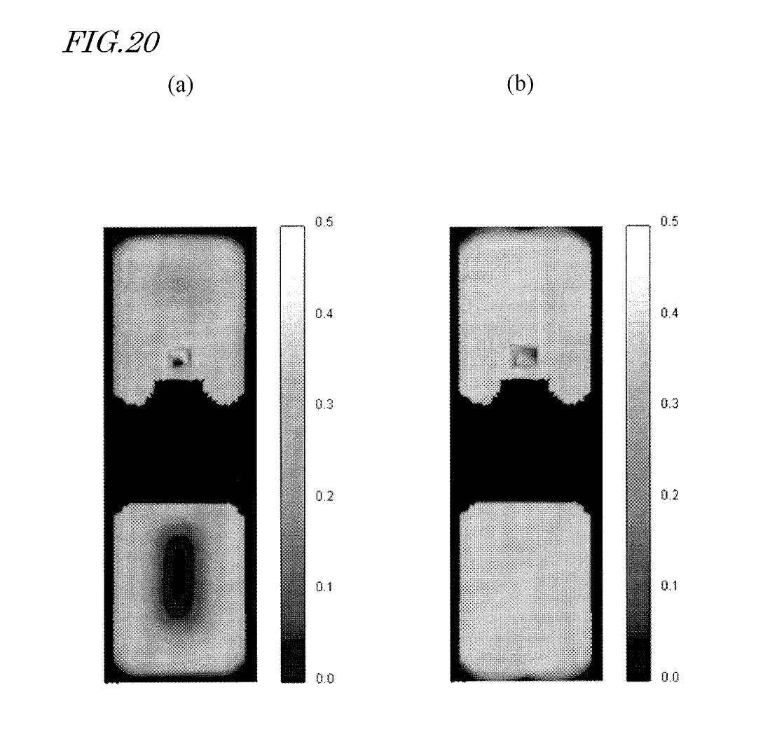

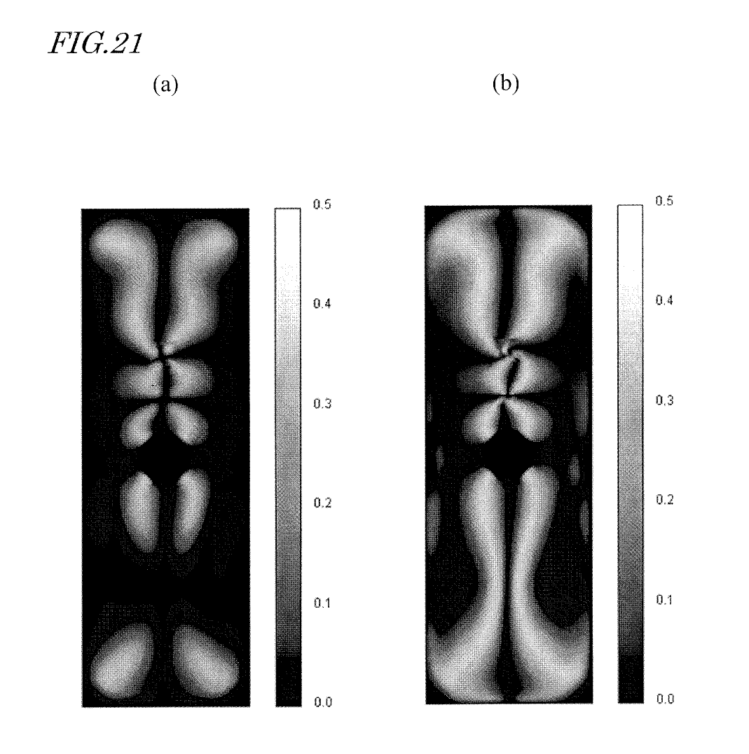

FIG. 19 shows the result of a simulation that was carried out on this liquid crystal display device 100′ to predict the alignment of the liquid crystal molecules 31 when a voltage is applied to the liquid crystal layer 30. FIGS. 20 and 21 show the results of simulations that were carried out on this liquid crystal display device 100′ to predict the transmittances of a pixel when a voltage is applied to the liquid crystal layer 30. Specifically, FIGS. 20(a) and 20(b) represent a situation where circular polarizers are provided as a pair of polarizers outside of the LCD panel. On the other hand, FIGS. 21(a) and 21(b) represent a situation where linear polarizers are provided as a pair of polarizers outside of the LCD panel. Also, FIGS. 20(a) and 21(a) represent a situation where a voltage of 3.5 V is being applied to the liquid crystal layer 30. Meanwhile, FIGS. 20(b) and 21(b) represent a situation where a voltage of 5 V is being applied to the liquid crystal layer 30.

As can be seen from FIG. 19, FIGS. 20(a) and 20(b) and FIGS. 21(a) and 21(b), a liquid crystal domain with stabilized axisymmetric alignment that had been hardly disturbed was produced around the columnar spacer 24 (i.e., the sub-spacer 24s).

It should be noted that the counter substrate 20 suitably has no additional columnar spacers other than the ones provided in a region corresponding to substantially the center of each liquid crystal domain in any of the liquid crystal display devices 100 and 100′ described above. The reason is that if any additional columnar spacers were provided in those regions, the alignments would be disturbed in the vicinity of those additional columnar spacers in the same way as already described with reference to FIGS. 14, 15(a) and 15(b).

Furthermore, for the reasons to be described below, each signal line SL of the active-matrix substrate 10 suitably has a zigzag shape which meanders so as to cross respective pixels of its associated row of pixels as shown in FIG. 1, for example. In that case, the signal line SL will include a portion located on the right-hand side of the pixel electrode 11 over a portion where the signal line SL crosses the pixel and a portion located on the left-hand side of the pixel electrode 11 under the portion where the signal line SL crosses the pixel.

Since there is a parasitic capacitance (i.e., source-drain capacitance) Csd between the pixel electrode 11 and the signal line SL, the potential at the pixel electrode 11 to be retained in each pixel for one frame period varies according to the amplitude of a display signal to be supplied onto the signal line SL. In general, a pattern is formed by lens scan exposure or stepper exposure, for example, during the manufacturing process. However, the position of the signal line SL to be arranged between the pixel electrodes 11 within the panel plane shifts according to the variation in pattern forming accuracy (i.e., arrangement accuracy). If a driving method in which the polarity of the voltage applied to the liquid crystal layer 30 inverts between pixels which are adjacent to each other in the row direction (e.g., the dot inversion drive) is adopted, the difference in parasitic capacitance due to this positional shift may cause a difference in retained voltage between the pixels and may be sensed as unevenness.

If a signal line SL to supply a display signal to the pixel electrode 11 of one pixel is called “its own source” and if a signal line SL to supply a display signal to the pixel electrode 11 of another pixel which is adjacent to the former pixel in the row direction is called “another source”, the potential at the pixel electrode 11 is affected by not only a variation in voltage at its own source but also a variation in voltage at another source.

If the signal line SL has a zigzag shape as shown in FIG. 1, for example, no matter whether the alignment between the signal line SL and the pixel electrode 11 has shifted rightward or leftward, its own source-drain capacitance and another source-drain capacitance will either both increase or both decrease. That is to say, if its own source-drain capacitance has increased, another source-drain capacitance also increases. As a result, a variation in parasitic capacitance can be canceled. Consequently, in a display mode to be used ordinarily, the display unevenness can be suppressed.

Furthermore, the number of liquid crystal domains to be produced in each pixel upon the application of a voltage does not have to be one or two as described above. But three or more liquid crystal domains may be produced in each pixel as well. Also, if multiple liquid crystal domains are produced, the pixel electrode 11 may be divided by a hole, instead of the notched portion 11b.

### INDUSTRIAL APPLICABILITY

An embodiment of the present invention provides a CPA mode liquid crystal display device in which trace unevenness is suppressed. Since the trace unevenness can be suppressed, the liquid crystal display device of the present invention can be used effectively in the display section of a smart phone or a tablet display device.

### REFERENCE SIGNS LIST

10 active-matrix substrate (first substrate)
10a, 20a transparent substrate
11 pixel electrode
11a subpixel electrode
11b notched portion (slit)
12 thin-film transistor (TFT)
12g gate electrode
12s source electrode
12d drain electrode
12a semiconductor layer
13 interlayer insulating film
13a contact hole
14 storage capacitor counter electrode
15 gate insulating film
16 storage capacitor electrode
20 counter substrate (second substrate)
21 counter electrode
22 color filter layer
22R red color filter
22G green color filter
22B blue color filter
23 shielding layer
23a contact hole shielding portion
23b TFT shielding portion
24 columnar spacer
24m main spacer
24s sub-spacer
30 liquid crystal layer
31 liquid crystal molecule
GL scan line
SL signal line
CsL storage capacitor line
100, 100′ liquid crystal display device

1. A liquid crystal display device comprising:
a plurality of pixels arranged in a matrix pattern;
a first substrate on which a pixel electrode is provided for each of the plurality of pixels;
a second substrate including a counter electrode arranged to face the pixel electrodes; and
a vertical alignment liquid crystal layer interposed between the first and second substrates,
at least one liquid crystal domain with axisymmetric alignment being produced when a voltage is applied between the pixel electrode and the counter electrode in each of the plurality of pixels,
wherein the second substrate further includes an alignment controlling projection and a plurality of columnar spacers, the projection being arranged in a region corresponding to substantially the center of the at least one liquid crystal domain and inducing liquid crystal molecules in the at least one liquid crystal domain to get aligned axisymmetrically,
the plurality of columnar spacers includes a first columnar spacer and a second columnar spacer which is lower than the first columnar spacer,
the pixel electrode has a length of 35 μm or less as measured along its shorter sides,
in at least some of the pixels, the second columnar spacer functions as the alignment controlling projection, and
the height of the second columnar spacer is 75% to 92% of the height of the first columnar spacer.

2. The liquid crystal display device of claim 1, wherein the at least one liquid crystal domain includes a plurality of liquid crystal domains, and
the pixel electrode includes a plurality of subpixel electrodes associated with the plurality of liquid crystal domains.

3. The liquid crystal display device of claim 2, wherein the first substrate further includes a thin-film transistor provided for each of the plurality of pixels and an interlayer insulating film covering the thin-film transistors,
a contact hole is cut through the interlayer insulating film to electrically connect the pixel electrode to the thin-film transistor, and
the contact hole is arranged so as to overlap with the alignment controlling projection that is associated with one of the plurality of liquid crystal domains when viewed along a normal to a display screen.

4. The liquid crystal display device of claim 3, wherein the thin-film transistor is arranged so as to overlap with the alignment controlling projection that is associated with another one of the plurality of liquid crystal domains when viewed along a normal to the display screen.

5. The liquid crystal display device of claim 4, wherein the second substrate further includes a shielding layer, and
the shielding layer includes first and second shielding portions which overlap with the contact hole and the thin-film transistor, respectively, when viewed along a normal to the display screen.

6. The liquid crystal display device of claim 2, wherein in each of the plurality of pixels, the second columnar spacer functions as the alignment controlling projection that is associated with at least some of the plurality of liquid crystal domains.

7. (canceled)

8. The liquid crystal display device of claim 1, wherein the at least one liquid crystal domain includes only one liquid crystal domain.

9. The liquid crystal display device of claim 8, wherein the first substrate further includes a thin-film transistor provided for each of the plurality of pixels, and
the thin-film transistor is arranged so as to overlap with the alignment controlling projection when viewed along a normal to the display screen.

10. The liquid crystal display device of claim 9, wherein the second substrate further includes a shielding layer, and
the shielding layer includes a shielding portion which overlaps with the thin-film transistor when viewed along a normal to the display screen.

11. The liquid crystal display device of claim 8, wherein in some of the plurality of pixels, the first columnar spacer functions as the alignment controlling projection and in the other pixels, the second columnar spacer functions as the alignment controlling projection.

12. The liquid crystal display device of claim 1, wherein each of the plurality of columnar spacers is either the first or second columnar spacer that functions as the alignment controlling projection, and
the second substrate has no additional columnar spacers which are provided anywhere but the region corresponding to substantially the center of the at least one liquid crystal domain.

13. (canceled)

14. A liquid crystal display device comprising:
a plurality of pixels arranged in a matrix pattern;
a first substrate on which a pixel electrode is provided for each of the plurality of pixels;
a second substrate including a counter electrode arranged to face the pixel electrodes; and
a vertical alignment liquid crystal layer interposed between the first and second substrates,
at least one liquid crystal domain with axisymmetric alignment being produced when a voltage is applied between the pixel electrode and the counter electrode in each of the plurality of pixels,
wherein the first substrate further includes a thin-film transistor provided for each of the plurality of pixels,
the second substrate further includes an alignment controlling projection and a plurality of columnar spacers, the projection being arranged in a region corresponding to substantially the center of the at least one liquid crystal domain and inducing liquid crystal molecules in the at least one liquid crystal domain to get aligned axisymmetrically,
the plurality of columnar spacers includes a first columnar spacer and a second columnar spacer which is lower than the first columnar spacer,
in at least some of the pixels, the second columnar spacer functions as the alignment controlling projection, and
the thin-film transistor is arranged so as to overlap with the alignment controlling projection that is associated with one of the at least one liquid crystal domain when viewed along a normal to a display screen.

15. The liquid crystal display device of claim 14, wherein the at least one liquid crystal domain includes a plurality of liquid crystal domains, and
the pixel electrode includes a plurality of subpixel electrodes associated with the plurality of liquid crystal domains.

16. The liquid crystal display device of claim 15, wherein the first substrate further includes an interlayer insulating film covering the thin-film transistors,
a contact hole is cut through the interlayer insulating film to electrically connect the pixel electrode to the thin-film transistor, and
the contact hole is arranged so as to overlap with the alignment controlling projection that is associated with one of the plurality of liquid crystal domains when viewed along a normal to the display screen.

17. The liquid crystal display device of claim 16, wherein the second substrate further includes a shielding layer, and
the shielding layer includes first and second shielding portions which overlap with the contact hole and the thin-film transistor, respectively, when viewed along a normal to the display screen.

18. The liquid crystal display device of claim 15, wherein in each of the plurality of pixels, the second columnar spacer functions as the alignment controlling projection that is associated with at least some of the plurality of liquid crystal domains.

19. (canceled)

20. The liquid crystal display device of claim 14, wherein the at least one liquid crystal domain includes only one liquid crystal domain.

21. The liquid crystal display device of claim 20, wherein the second substrate further includes a shielding layer, and
the shielding layer includes a shielding portion which overlaps with the thin-film transistor when viewed along a normal to the display screen.

22. The liquid crystal display device of claim 20, wherein in some of the plurality of pixels, the first columnar spacer functions as the alignment controlling projection and in the other pixels, the second columnar spacer functions as the alignment controlling projection.

23. The liquid crystal display device of claim 14, wherein each of the plurality of columnar spacers is either the first or second columnar spacer that functions as the alignment controlling projection, and
the second substrate has no additional columnar spacers which are provided anywhere but the region corresponding to substantially the center of the at least one liquid crystal domain.

24-25. (canceled)
